(19) United States
(12) Patent Application Publication
(10) Pub. No.: US 2009/0071743 A1
(43) Pub. Date: Mar. 19, 2009

(54) Electrical steering system for vehicle

(76) Inventor: Rexhep Gashi, Givisiez (CH)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/988,766

(22) PCT Filed: Jul. 11, 2006
(86) PCT No.: PCT/EP2006/064084

§ 371 Date: Jan. 14, 2008

(30) Foreign Application Priority Data
Jul. 13, 2005 (FR) 0507678

(51) Int. Cl. B62D 5/04

(52) U.S. Cl. 180/402; 180/444

(57) ABSTRACT

A ground contact system (1) for a motor vehicle, said ground contact system comprising a steered wheel (2) and a suspension device (3) for said wheel within which non-suspended elements are integral with the axis of the wheel and suspended elements are intended to be integral with the body of the vehicle, in which the steering of the wheel is directly controlled by an electric actuator (9), said actuator acting between suspended elements (8, 10).

The present invention relates to the steering of highway motor vehicles. More particularly, it relates to an electrical steering system without any mechanical linkage between the steered wheels and the steering wheel, which is referred to as “electrical steering” for greater simplicity. This type of steering is also very commonly referred to as “steer by wire”.

In electrical steering, the following mechanism is substituted for the traditional mechanical controls that exist between the steering wheel and the steered wheels and which may be assisted or unassisted. At the wheel level, there is an electrical actuator, preferably an individual one for each wheel, the purpose of which is to set the appropriate steering angle for the wheel or wheels in question. The steering controls available to the driver of the vehicle may be a traditional steering wheel or a lever such as a joystick, or any other suitable device. The commands given by the driver of the vehicle to his or her control device are sent to the actuators via an electrical link, with the entire system being placed under the supervision of a computer loaded with programs suitable for driving the actuator or actuators appropriately.

One of the advantages of this technology is that it is ideally compatible with electronics, the advances in which are making increasingly sophisticated feedback control systems possible, so that the steering of the road wheels can not only be subject to the manual controls but also to control by a safety system. Thus, for example, the steered wheels may be set to a steering angle which not only takes into account the instructions from the driver of the vehicle but which also takes into account the dynamic parameters observed on the vehicle.

The principle of such an electrical steering system is described in application EP 1 428 740.

The present invention relates in particular to the mechanical lay-out of the electrical steering within the ground contact system of vehicles.

The invention proposes a ground contact system for a motor vehicle, said ground contact system comprising a steered wheel and a suspension device for said wheel within which non-suspended elements are integral with the wheel axis and suspended elements are intended to be integral with the body of the vehicle, in which the steering of the wheel is directly controlled by an electric actuator, said actuator acting between suspended elements. Preferably, the electric actuator is a telescopic actuator.

More preferably still, the vertical suspension of the vehicle is provided by a slide mechanism located in the volume of the wheel, said slide mechanism comprising a substantially vertical bar integral with the wheel carrier and a slide sliding on the bar, said slide itself being mounted to rotate relative to a support arm connected to the body of the vehicle, the rotation of the slide relative to the support arm permitting the steering movement of the wheel carrier about a substantially vertical axis. Preferably, the electric actuator acts between the support arm and a lever integral with the slide.

Preferably, the actuator comprises a screw which is moved axially by the rotation of a nut, the nut being integral with a shaft of a rotary electric motor. Preferably, the actuator comprises two electrically independent motors, the shaft being integral with each of the two rotors of the two motors.

The invention also proposes a telescopic electric screw actuator for the steering of such a ground contact system, said actuator comprising a body, a rod, at least one rotary electric motor, the rod being moved by the motor by means of a screw/nut system, the nut being driven in rotation by the shaft of said at least one electric motor, one end of the screw being guided in translation within a tube integral with the body, said tube being located within the shaft.

Preferably, the actuator comprises at least two independent rotor/stator assemblies, the stators being integral with the body of the actuator, the rotors being integral with the nut by means of the shaft, the rod being integral with the screw. Preferably, the shaft is guided in rotation relative to the body by rolling bearings. Preferably, the tube furthermore bears radially on the inside of the shaft.

Preferably, the actuator furthermore comprises mechanical stops for the travel of the rod.

The invention is illustrated by means of the appended figures, in which:

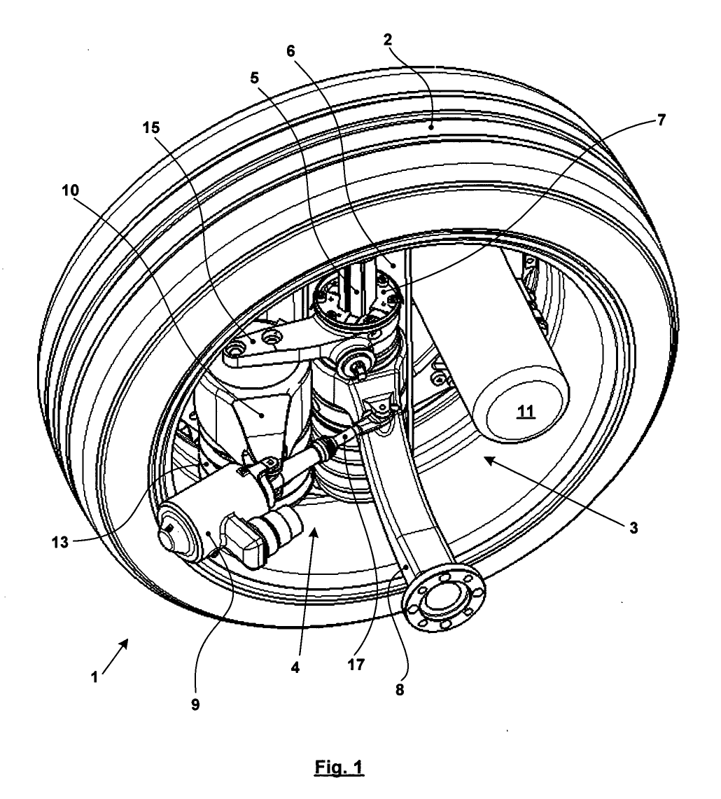

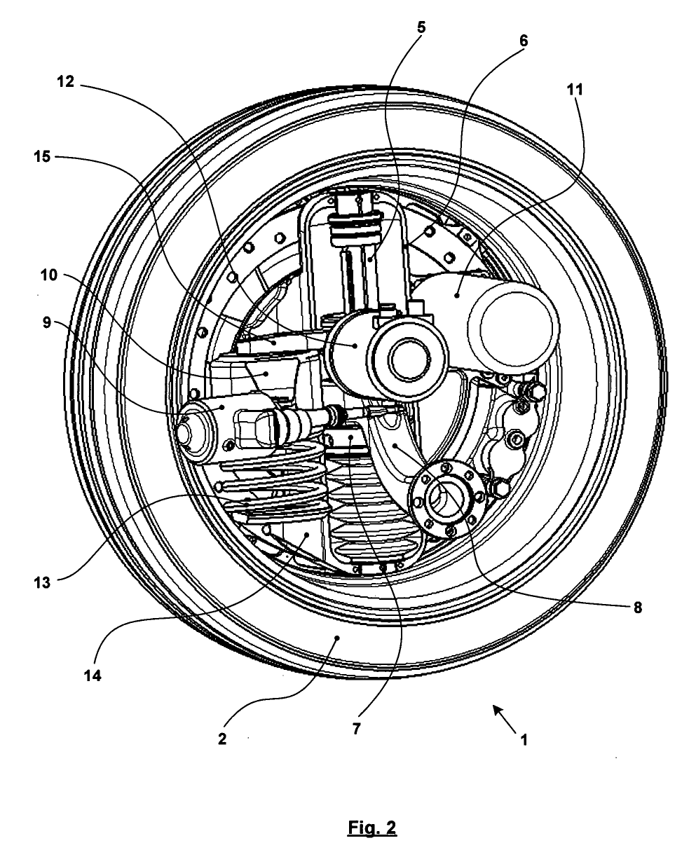

FIGS. 1 and 2 are perspective views of a preferred embodiment of the ground contact system according to the invention.

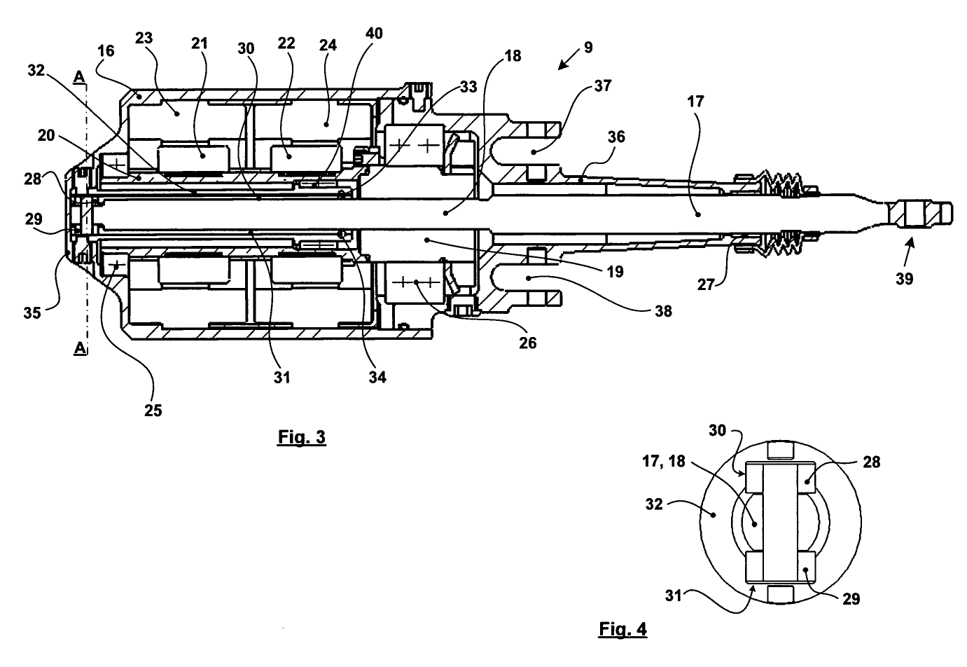

FIGS. 3 and 4 are sectional views of a preferred embodiment of the telescopic electric actuator for the ground contact system according to the invention.

FIGS. 1 and 2 depict a ground contact system 1 according to the invention. This ground contact system comprises a steered wheel 2 connected by a suspension device 3 to the body of a vehicle (not shown). The suspension here comprises a slide mechanism 4 composed of a bar 5 integral with the wheel carrier 6 and a slide 7 in which the bar 5 moves to permit substantially vertical suspension movements of the wheel relative to the body of the vehicle. The slide is mounted to rotate relative to the support arm 8 in order to permit the steering movements of the wheel. The support arm 8 is intended to be integral with the vehicle (not shown).

The turning of the wheel is controlled by an electric actuator 9 acting between the support arm 8 and a steering lever 10 integral with the slide 7.

It will be understood that (in accordance with terminology accepted in the automobile field) the slide 7, the steering lever 10 and the support arm 8 are suspended elements because they are integral with the vehicle with regard to the suspension movement, whereas the wheel 2, the bar 5 and the wheel carrier 6 are non-suspended elements because they are integral with the wheel axis with regard to the suspension movement.

The steering of the wheel is thus directly controlled by the electric actuator, the latter acting between suspended elements of the ground contact system. No crank mechanism or link rod is in fact necessary to transmit the movement of the actuator to the wheel.

The ground contact system may furthermore comprise an electric traction motor 11, and an electric machine 12 controlling the suspension movements as described in Applications EP 0 878 378 or FR 04/09986. Furthermore, a suspension spring 13 may act between the suspended and non-suspended elements of the suspension. The electric machine 12 has been omitted from FIG. 1 to promote understanding of the drawings. The spring 13 preferably acts between the wheel carrier 6 and the slide 7 respectively by means of a lower spring bearing surface 14 and an upper spring bearing surface 15. Preferably, the steering lever 10 is integral with the slide 7 through the upper bearing surface 15.

FIG. 3 depicts in axial section one preferred embodiment of the steering actuator according to the invention. The actuator 9 is here depicted in its totally retracted position. FIG. 4 is a section in the plane A-A of FIG. 3 showing, on an enlarged scale, how the rear end of the rod is guided in the tube 32.

In FIGS. 3 and 4, it can be seen that the telescopic electric actuator 9 comprises mainly a body 16 and a rod 17, the rod being driven in a translational movement relative to the body. The rod 17 is integral with a screw 18 cooperating with a nut 19 integral with a motor shaft 20. A first rotor 21 and a second rotor 22 are integral with the shaft 20 and cooperate respectively with a first stator 23 and a second stator 24. Thus two electrically independent motors act on a common shaft. Preferably, the motors are synchronous motors without brushes (“brushless”).

The shaft+nut assembly is guided in rotation relative to the body 16 by means of rear 25 and front 26 rolling bearings. The rod 17 is guided in translation relative to the front part 36 of the body 16 by means of a front journal bearing 27. The rear end of the rod is guided relative to the body by means of rollers 28 and 29 which roll in grooves 30 and 31 located within a tube 32. The tube 32 is located to the inside of the motor shaft 20. The rear end of the tube 32 is integral with the body 16. In order to increase the rigidity of the guiding, the front end of the tube may bear radially to the inside of the shaft by means of a plain journal bearing or a for example needle rolling bearing 40.

The position of the rod is preferably controlled by means of the control for the motors with the exception of any specific sensor. Preferably, stops limit the travel of the rod, in extension and in contraction. In the direction of extension of the actuator, the rollers 28 and 29 come to bear on stops 33 and 34 for the tube 32. In the direction of contraction of the actuator (that is to say in the rod position shown in FIG. 3), the rear end of the rod comes to bear against the bottom 35 of the body 16. The touching of these stops may be detected by the electric control for the motors and may make it possible for the electrical steering system to initialise or re-initialise its position calculation.

The front part 36 of the body 16 comprises means (brackets 37, 38) for connection to the suspended elements of the ground contact system. Likewise, the distal end 39 of the rod 17 comprises means for connection to said suspension elements. These connections (which can be better seen in FIG. 1) must permit sufficient oscillation for the intended steering movement. For a compact automobile, it is generally desired for a front steered wheel to be able to turn by at least 35° towards the outside (toe out) and 25° towards the inside (toe in).

The actuator according to the invention is thus extremely compact with regard to its travel. Furthermore, the fact that it comprises two electrically independent motors may make possible redundancy of the data relating to the steering of the wheel and operation in degraded mode at reduced power with a single motor.

The ground contact system and the actuator according to the invention may be used within vehicles having 2, 3 or 4 wheels or more, the steered wheels being located at the front and/or the rear of said vehicles.

One advantage of the ground contact system according to the invention is that it groups all the functions in the wheel or in the immediate proximity of the wheel although the means for controlling the steering remain suspended. When the vehicle furthermore comprises height control means such as those described in French patent application filed under the number FR 04/07897, that is to say that the position of the support arm relative to the body of the vehicle may be modified to vary the height of the vehicle, it is possible according to the present invention to choose to place the telescopic steering actuator for example between the upper spring support and the suspension support 4 or between the steering lever 13 and the take-up lever 12 (bracket 14) or between the suspension support 4 and the steering lever 13 (the reference numbers here are those of application FR 04/07897, see in particular FIGS. 1 and 3). The support arm (reference 8 in the present description) has a function identical to that of the “suspension support” which bears reference 4 in application FR 04/07897.

The French patent application filed under the number FR 04/09986 describes in detail a preferred embodiment of the suspension, traction and braking means of the ground contact system according to the invention.

1. A ground contact system (1) for a motor vehicle, said ground contact system comprising a steered wheel (2) and a suspension device (3) for said wheel within which non-suspended elements are integral with the axis of the wheel and suspended elements are intended to be integral with the body of the vehicle, in which the steering of the wheel is directly controlled by an electric actuator (9), said actuator acting between suspended elements (8, 10).

2. The ground contact system according to claim 1, in which the electric actuator is a telescopic actuator.

3. The ground contact system according to claim 1, in which the vertical suspension of the vehicle is provided by a slide mechanism (4) located in the volume of the wheel, said slide mechanism comprising a substantially vertical bar (5) integral with the wheel carrier (6) and a slide (7) sliding on the bar, said slide itself being mounted to rotate relative to a support arm (8) connected to the body of the vehicle, the rotation of the slide relative to the support arm permitting the steering movement of the wheel carrier about a substantially vertical axis.

4. The ground contact system according to claim 2, in which the electric actuator (9) acts between the support arm (8) and a lever (10) integral with the slide.

5. The ground contact system according to claim 2, in which the actuator comprises a screw (18) which is moved axially by the rotation of a nut (19), the nut being integral with a shaft (20) of a rotary electric motor (21, 23).

6. The ground contact system according to claim 5, in which the actuator comprises two electrically independent motors, the shaft (20) being integral with each of the two rotors (21, 22) of the two motors.

7. A telescopic electric screw actuator for the steering of a ground contact system according to one of the preceding claims, said actuator comprising a body (16), a rod (17), at least one rotary electric motor, the rod being moved by the motor by means of a screw/nut system (18-19), the nut being driven in rotation by a shaft (20) of said at least one electric motor, one end of the screw being guided in translation within a tube (32) integral with the body, said tube being located within the shaft.

8. The actuator according to claim 7, comprising at least two independent rotor/stator assemblies (21, 23, 22, 24), the stators (23, 24) being integral with the body of the actuator, the rotors (21, 22) being integral with the nut (19) by means of the shaft, the rod (17) being integral with the screw (18).

9. The actuator according to claim 7, in which the shaft is guided in rotation relative to the body by rolling bearings (25, 26).

10. The actuator according to claim 7, in which the tube furthermore bears radially within the shaft.

11. The actuator according to one of claim 7, furthermore comprising mechanical stops (33, 34, 35) for the travel of the rod.
